(19) United States
(12) Patent Application Publication
(10) Pub. No.: US 2022/0281758 A1
(43) Pub. Date: Sep. 8, 2022

(54) BORON AND BROMINE RECOVERY SYSTEM

(71) Applicant: Enviro Water Minerals Company, Inc., Houston, TX (US)

(72) Inventor: Paul Steven Wallace, Austin, TX (US)

(21) Appl. No.: 17/633,481

(22) PCT Filed: Aug. 7, 2020
(86) PCT No.: PCT/US20/45493

§ 371 Date: Feb. 7, 2022

Related U.S. Application Data
(60) Provisional application No. 62/883,854, filed on Aug. 7, 2019.

(51) Int. Cl. C02F 1/44

(52) U.S. Cl. CPC C02F 1/442; C02F 1/444; C02F 2101/108

(57) ABSTRACT

The present disclosure is generally directed to a water processing system. In some embodiments, the water processing system includes a boron removal system that generally produces a boric acid concentrate stream and a softened brine stream based on a NF non-permeate stream, and the NF non-permeate stream includes boron. The system also a boric acid recovery system that generally receives the boric acid concentrate stream and generates boric acid from the boric acid concentrate stream.

### CROSS REFERENCE TO RELATED APPLICATION

This application benefits from the priority of U.S. Provisional Patent Application No. 62/883,854, entitled “Boron and Bromine Recovery System,” filed Aug. 7, 2019, which is hereby incorporated by reference in its entirety.

### BACKGROUND

The subject matter disclosed herein generally relates to desalination systems, and more particularly to a system for recovering boron and bromine.

There are several regions in the United States (e.g., the southwestern United States including New Mexico, Southern California, and parts of Texas) and throughout the world that experience shortages in potable water supplies due, in part, to the arid climate of these geographic locales. As water supplies are limited, innovative technologies and alternative water supplies for both drinking water and agriculture may be utilized. One method for obtaining an alternative source of potable water uses desalination systems to produce the potable water.

The desalination process may involve the removal of salts from seawater, agricultural run-off water, and/or brackish ground water brines to produce potable water. Membrane-based desalination may use an assortment of filtration methods, such as nanofiltration and reverse osmosis, to separate the raw brine stream into a desalinated water stream and a tailing stream. The tailing streams may contain various salts and other materials left over after the desalination process. Included in these tailing streams may be valuable salts and minerals which may be extracted using membrane-based and/or evaporative techniques.

### BRIEF DESCRIPTION

The present disclosure generally relates to a system. In some embodiments, the system may include a nanofiltration (NF) system that generally produces an NF permeate stream and an NF non-permeate stream from a brine stream from a water treatment system. The NF permeate stream includes boron. The system also includes a boron removal system disposed downstream from the NF system and generally produces a boric acid concentrate stream and a softened brine stream based on the NF non-permeate stream, and the NF non-permeate stream includes boron. The system also a boric acid recovery system that generally receives the boric acid concentrate stream and generates boric acid from the boric acid concentrate stream.

In another embodiment, the present disclosure relates to a system that includes a nanofiltration (NF) system that generally produces an NF permeate stream and an NF non-permeate stream from a brine stream from a water treatment system. The NF permeate includes boron and the NF non-permeate stream includes boron. The system also includes a boron removal system disposed downstream of the NF system and generally produces a boric acid concentrate stream and a softened brine stream based on the NF non-permeate stream. Further, the system includes a bromine recovery system disposed downstream from the boron removal system. The bromine recovery system generally produces bromine based on the softened brine stream.

In another embodiment, the present disclosure relates to a method that includes directing a feed stream to a nanofiltration (NF) system disposed upstream of a mineral removal system and the feed stream includes a plurality of minerals. The method also includes generating an NF permeate stream and an NF non-permeate stream from the feed stream via the NF unit and the NF non-permeate stream includes a first portion of the plurality of minerals, and the NF permeate stream includes a second portion of the plurality of minerals. Further, the method includes directing the NF non-permeate stream to a gypsum recovery system. The gypsum recovery system generally removes the first portion of the plurality of minerals from the NF non-permeate stream to generate a gypsum filtrate stream and the gypsum filtrate includes boron. Further still, the method includes supplying the gypsum filtrate to a boron removal system. The boron removal system generally produces a boron rich stream and a non-boron containing stream. Even further, the method includes supplying the boron rich stream to a boric acid recovery system. The boric acid recovery system generally produces boric acid and boron free brine solution including a third portion of the plurality of minerals based on the boron rich stream.

In another embodiment, the present disclosure relates to a nanofiltration (NF) system that generally produces an NF permeate stream and an NF non-permeate stream from a brine stream from a water treatment system. The NF permeate stream includes gypsum. The system also includes a gypsum recovery system disposed downstream from the NF system and generally receives the NF non-permeate stream. The gypsum recovery system includes an NF unit configured to generate second NF-permeate based on the NF non-permeate stream. The second NF-permeate is substantially free of antiscalant. The gypsum recovery system generally produces gypsum based on second NF-permeate.

In another embodiment, the present disclosure relates to a system that includes nanofiltration (NF) system configured to generate an NF permeate stream and an NF non-permeate stream from a brine stream from a water treatment system, wherein the NF permeate stream includes bromide ions. The system also includes a bromine recovery system disposed downstream from the NF system. The bromine recovery system includes at least two distillation columns configured to generate bromine based on at least in part on a refluxed second brine stream based on the brine stream.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an embodiment of a water processing system, in accordance with aspects of the present disclosure;

FIG. 2A is a block diagram of a first portion of an embodiment of a water processing system that may be employed within the water processing system of FIG. 1, in which the water processing system includes a boron removal system and a boric acid recovery system, in accordance with aspects of the present disclosure;

FIG. 2B is a block diagram of a second portion of the water processing system of FIG. 2A, in which the water processing system also includes a bromine recovery system, in accordance with aspects of the present disclosure;

FIG. 3 is a block diagram of an embodiment of a boron removal system that may be employed within the water processing system of FIGS. 2A-2B, in accordance with aspects of the present disclosure;

FIG. 4 is a block diagram of an embodiment of a boric acid recovery system that may be employed within the water processing system of FIGS. 2A-2B, in accordance with aspects of the present disclosure;

FIG. 5 is a block diagram of an embodiment of a bromine recovery system that may be employed within the water processing system of FIGS. 2A-2B, in accordance with aspects of the present disclosure;

FIG. 6 is a block diagram of an embodiment of a gypsum recovery system that may be employed within the water processing system of FIGS. 2A-2B, in accordance with aspects of the present disclosure;

FIG. 7 is a block diagram of an embodiment of an aquaculture system that may be employed within the water processing system of FIGS. 2A-2B, in accordance with aspects of the present disclosure; and

FIG. 8 is a flow diagram of an embodiment of a method for extracting minerals from feed stream received by a water processing system to generate minerals such as boric acid, bromine, and gypsum, in accordance with the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

In water desalination processes, ion separation systems are used to extract minerals (e.g., calcium, magnesium, sodium, and sulfate) from tailing streams (e.g., the nanofiltration and reverse osmosis non-permeate streams) that may otherwise be discarded. The extracted minerals may be recovered as industrial grade products for commercial use. However, it may be difficult to separate certain minerals (e.g., gypsum, boron, and bromine) from the tailing streams, which may result in the minerals being discarded. Accordingly, and as discussed in detail below, the disclosed embodiments include a water processing system (e.g., desalination system) configured to desalinate water (e.g., seawater, agricultural run-off water-off water, and/or brackish ground water), and recover minerals extracted from the desalinated water, such as gypsum, boron, and bromine. Additionally, the disclosed embodiments include a water processing system that pretreats seawater, which avoids or reduces a likelihood of producing a concentrate that may contain organic biofilm material and/or fine particulates. Moreover, unlike certain conventional desalination plants that reject the organic biofilm material back to the sea, the water processing system in accordance with the present disclosure uses the concentrate as a high purity feedstock for minerals recovery.

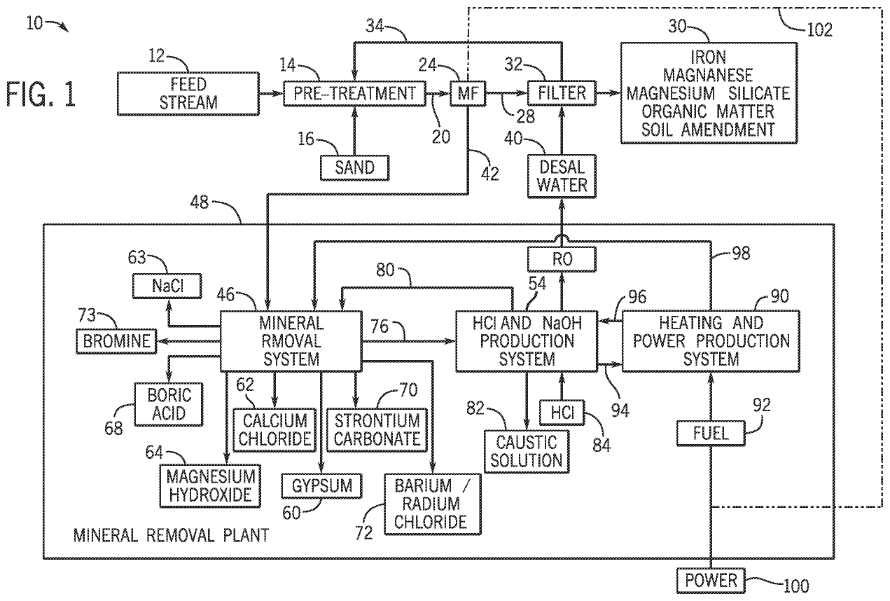

With the foregoing in mind, FIG. 1 is a block diagram of an embodiment of a water processing system 10 that may be used to treat a boron and bromine brine stream and recover commercially viable materials from produced water in a manner that significantly reduces (or eliminates) waste byproducts. For example, the water processing system 10 may be part of a water desalination system, wastewater treatment system, water purification system, oil and gas brine treatment system, or any other suitable water processing system. In the illustrated embodiment, the water processing system 10 is used to produce desalinated water from a feed stream (e.g., produced water) containing hydrocarbons and other organic components. In addition, the water processing system 10 may remove and recovery minerals, salts, and other commercially viable materials that may be present in the hydrocarbon-containing feed stream. For example, the water processing system 10 may be used to produce soil amendment, magnesium hydroxide, boric acid, barite, high purity agricultural grade gypsum (CaSO.2H₂O) (e.g., greater than 97 weight percent (wt %) gypsum on a dry basis), industrial grade caustic (e.g., greater than 97 wt % sodium hydroxide (NaOH) on a dry basis), industrial grade magnesium hydroxide (Mg(OH)₂) (e.g., greater than 95 wt % MgO on an ignited basis, or on an ignited oxide basis) suitable for industrial magnesia refractory, industrial grade calcium chloride (CaCl₂)) (e.g., greater than 90 wt % CaCl₂) on a dry basis), concentrated HCl for commercial use (e.g., approximately 4 wt % to 35 wt %), desalinated water (e.g., less than 1 gram/Liter (g/L) (1000 parts per million (ppm)) total dissolved solids (TDS)), or a combination thereof, from the produced water. Furthermore, the water processing system 10 may use a combination of one or more of gypsum precipitation, magnesium hydroxide precipitation, electrodialysis (ED), ion exchange, softening, and membrane and filtration systems (e.g., microfiltration (MF), nanofiltration (NF), ultrafiltration (UF), reverse osmosis, vacuum cloth filters, pressure cloth filters) to remove the minerals from brines as industrial grade products and/or to substantially reduce (or eliminate) waste byproducts.

In the illustrated embodiment, the water processing system 10 includes a pretreatment system 14 configured to receive a feed stream 12 (e.g., produced water). The feed stream 12 may be received from any suitable water source. For example, in certain embodiments, the feed stream 12 may be from a hydrocarbon extraction process (e.g., produced water). In other embodiments, the feed stream 12 may be received from ground water, seawater, brackish water, and so forth. The feed stream 12 may contain various elements and/or compounds. For example, the feed stream 12 may contain sodium chloride (NaCl), sulfate (SO₄), calcium (Ca), magnesium (Mg), bromine (Br₂), boron (B), and/or silicon dioxide (silica or SiO₂), or a combination thereof. In certain embodiments, the feed stream 12 may contain approximately 0.50 g/L (500 ppm) to approximately 350.00 g/L (350,000 ppm) NaCl, approximately 0.010 g/L (10 ppm) to approximately 1.50 g/L (1,500 ppm) SO₄, approximately 0.01 g/L (10 ppm) to approximately 8.0 g/L (8000 ppm) Ca, Mg, and Ba, approximately 0.001 g/L (1 ppm) to approximately 0.1 g/l (100 ppm) B(OH)3, approximately 0.01 (10 ppm) g/L to approximately 1 g/L (1000 ppm) HCO3, and/or approximately 0.01 g/L (10 ppm) to approximately 0.30 g/L (300 ppm) SiO₂, or a combination thereof. Furthermore, in certain embodiments, the feed stream 12 may have a pH range between approximately 5 and 9. For example, the feed stream 12 may have a pH of approximately 8.

As discussed above, the feed stream 12 may be a brine stream resulting from hydrocarbon extraction processes. Accordingly, the feed stream 12 may contain hydrocarbon and other organic components that may render the feed stream 12 unsuitable for treatment in downstream processes of the water processing system 10. The feed stream 12 may contain emulsifiers (e.g., naphthenic acids) that stabilize the hydrocarbons in the feed stream 12. For example, the emulsifiers may solubilize the hydrocarbons in water. As such, the feed stream 12 may be a mixture of water, salts, hydrocarbons, and, in certain embodiments, suspended solids (e.g., sand and other solids). Therefore, as discussed in further detail below, the feed stream 12 may be treated with an acid (e.g., HCl) upstream, of the pretreatment system 14 to decrease a pH of the feed stream 12 to an acidic pH. The acidic pH of the feed stream 12 may destabilize the emulsion, such that the hydrocarbons and the water in the feed stream 12 separate.

The pretreatment system 14 receives the acidified feed stream 12 and removes suspended solid materials (e.g., sand 16) and hydrocarbons from the acidified feed stream 12 to generate a pretreated brine stream 20 that does not contain hydrocarbons and other organic materials (e.g., the hydrocarbons and other organic materials have been substantially removed). The pretreatment system 14 provides the pretreated brine stream 20 to a microfiltration (MF) system 24 that separates solid materials generated in the pretreatment system 14 from the pretreated brine stream 20. For example, the MF system 24 may include plastic or ceramic filters that remove certain components present in the pretreated brine stream 20 and produce a MF non-permeate stream 28 that includes solid materials 30 separated from the pretreated brine stream 20. The solid materials 30 may include solids such as, but not limited to, iron (Fe), manganese (Mn), manganese silicate, and organic matter found in and/or generated from the feed stream 12. The MF non-permeate stream 28 is directed to a first filter 32 (e.g., which may include a sand or diatomaceous earth precoat) that captures and recovers the solid materials 30 in the brine stream 28. For example, the first filter 32 captures solids in the brine stream 28 to generate the solid materials 30 and a filtrate 34 (e.g., an aqueous brine stream). The filtrate 34 may be recycled back to the pretreatment system 14, as discussed in further detail below. In certain embodiments, the first filter 32 may be flushed with desalinated water 40, which produced in a downstream process of the water processing system 10, after removal of the solid materials 30 to wash the first filter 32. The filter wash may be combined with the filtrate 34 and fed to the pretreatment system 14.

In addition to the MF non-permeate stream 28, the MF system 24 outputs a MF permeate stream 42 that contains dissolved salts and minerals (e.g., NaCl, Ca²⁺, SO4²⁻, Mg²⁺, etc.). The MF system 24 provides the MF permeate stream 42 to a mineral removal system 46 downstream of the pretreatment system 14. In certain embodiments, the MF permeate stream 42 may be approximately 80 percent to approximately 99 percent of the output from the MF system 24, and the MF non-permeate stream 28 may be approximately 1 percent to approximately 20 percent of the output from the MF system 24. For example, in some embodiments, the brine stream 42 may be approximately 95 percent of the output from the MF system 24, and the MF non-permeate stream 28 may be approximately 5 percent of the output from the MF system 24. While the illustrated embodiment uses the MF system 24, other embodiments may use an ultrafiltration (UF) system in place of the MF system 24.

The mineral removal system 46 may be part of a mineral removal plant 48. The mineral removal plant 48 is configured to remove minerals, elements, compounds, or combinations thereof, from the MF permeate stream 42. The MF permeate stream 42 may be provided to the mineral removal plant 48 from any suitable source and/or system. In certain embodiments, the MF permeate stream 42 may include substantial amounts of salts, such as NaCl, sodium sulfate (Na₂SO₄), calcium (Ca), magnesium (Mg), boron (B), Strontium (Sr), Bromine (Br), or combinations thereof. The minerals, elements, and compounds present in the MF permeate stream 42 may be recovered for commercial use. In addition, the NaCl in the brine stream 42 may be used to generate hydrochloric acid (HCl) and sodium hydroxide (NaOH) in a hydrochloric acid (HCl) and sodium hydroxide (NaOH) production system 54 of the mineral removal plant 48. The mineral removal system 46 may also output one or more desalination streams, which may contain SiO₂, including the desalinated water 40. Furthermore, the one or more desalination streams may include a disinfectant and/or oxidant.

During operation, the mineral removal system 46 may be configured to remove any suitable minerals, elements, compounds, or a combination thereof, from the brine stream 42. For example, the mineral removal system 46 may provide a gypsum stream 60 (e.g., agricultural grade gypsum), a calcium chloride stream 62 (e.g., industrial grade calcium chloride), a sodium chloride stream 63, a magnesium hydroxide stream 64 (e.g., industrial grade magnesium hydroxide), a boric acid stream 68 (e.g. industrial grade boric acid, such as greater than 99 percent B(OH)₃), a strontium carbonate stream 70 (e.g. industrial grade strontium carbonate, such as greater than 95 percent SrCO₃+BaCO₃), a barium/radium chloride stream 72, a bromine stream 73, other mineral streams depending on the mineral content of the brine stream 42, or a combination thereof.

The mineral removal system 46 may generate additional streams that may be collected for commercial use and/or utilized in a downstream process of the water processing system 10. In certain embodiments, the mineral removal system 46 may provide one or more output streams 76 to the HCl and NaOH production system 54. For example, the mineral removal system 46 may provide NaCl brine to the HCl and NaOH production system 54. The HCl and NaOH production system 54 may generate concentrated HCl via an ion separation process (e.g., EDBM process) followed by an evaporation process. Furthermore, the mineral removal system 46 may receive one or more input streams 80 from the HCl and NaOH production system 54. The one or more input streams 80 may provide the mineral removal system 46 with the HCl and/or caustic (e.g., NaOH) produced by the HCl and NaOH production system 54. In addition, the HCl and NaOH production system 54 may generate a caustic solution 82 (e.g., concentrated industrial grade NaOH) and/or a concentrated industrial grade HCl product solution 84 that is not used by the mineral removal system 46 (e.g., produced to be sold).

The mineral removal plant 48 also includes a heating and power production system 90. The heating and power production system 90 may include a natural gas engine and/or a boiler. The heating and power production system 90 may be configured to receive a fuel 92. The fuel 92 may be any suitable fuel, such as natural gas, synthetic natural gas (e.g., syngas), or combination thereof. The heating and power production system 90 may provide power, steam, hot water, any suitable heated fluid, and so forth to the HCl and NaOH production system 54, as indicated by arrow 94. Moreover, the heating and power production system 90 may receive a cooled fluid stream 96 (e.g., cooled water) from the HCl and NaOH production system 54. As illustrated, the heating and power production system 90 may also provide power to the mineral removal system 46, as indicated by arrow 98. Additionally, the heating and power production system 90 may provide power 100 to another system, and/or the heating and power production system 90 may provide power to the MF system 24, as indicated by arrow 102.

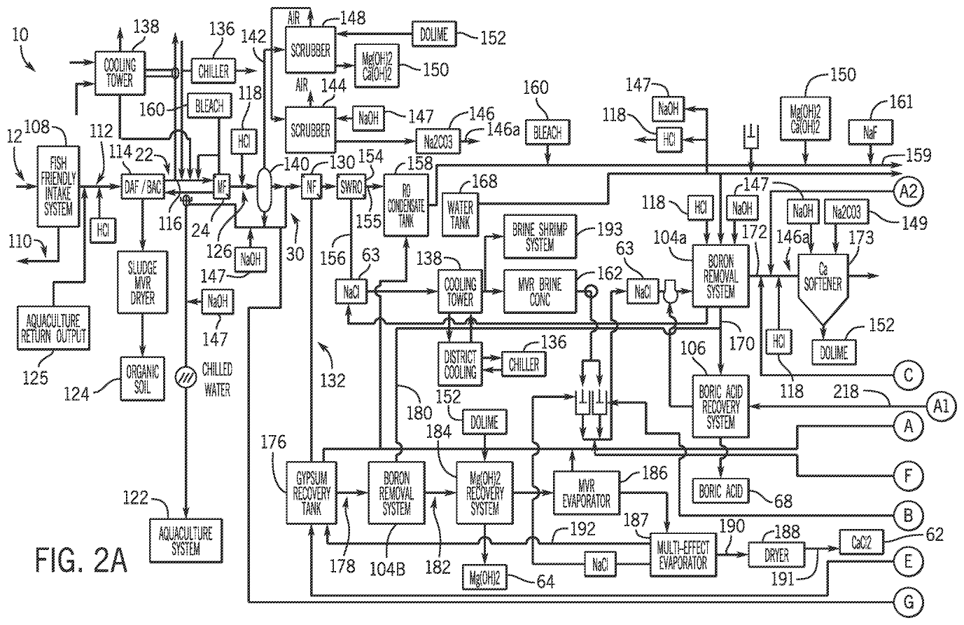

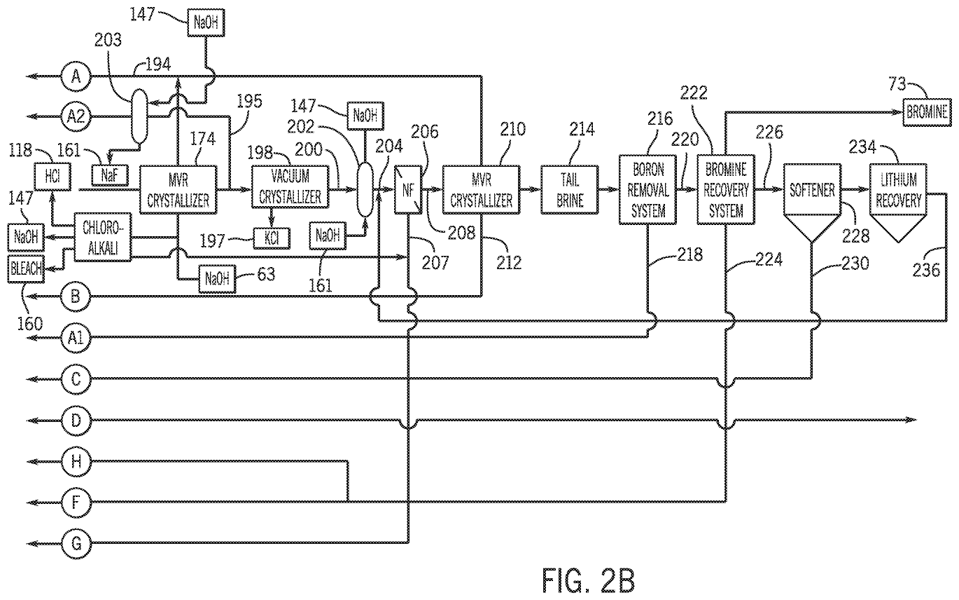

As discussed above, certain feed streams (e.g., the feed stream 12) may include boron and/or bromine that may be useful for certain industrial applications. FIG. 2A is a block diagram of a first portion of an embodiment of the water processing system 10 that includes a boron removal system 104 and a boric acid recovery system 106 configured to extract minerals from tailing streams such as nanofiltration and reverse osmosis non-permeate streams. Additionally, the water processing system 10 includes a gypsum recovery tank 176, a magnesium hydroxide recovery system 184, and a bromine recovery system (e.g., the bromine recovery system 222 as discussed with respect to FIG. 2B). It should be noted that at least these components (e.g., the gypsum recovery tank 176, the magnesium hydroxide recovery system 184, and the bromine recovery system 222 may be part of the mineral removal system 45 discussed above with respect to FIG. 1. For example, and as discussed above, the extracted minerals may include gypsum (CaSO.2H₂O), magnesium hydroxide (Mg(OH)₂), sodium chloride (NaCl), bromine (Br₂), boric acid (B(OH)₃), and the like, which may be provided by the components discussed in more detail below. Further, it should be noted that, at least in some instances, some of the components of the water processing system 10 may be omitted. For example, in some embodiments, at least one of the gypsum recovery system 176, the boron removal system 104, the boric acid recovery system 106, the bromine recovery system 222, the fish friendly intake system 108, and the aquaculture system 122, and the like, may be omitted.

As shown in the illustrated embodiment, the feed stream 12 is fed into a fish friendly intake system 108 to generate a second feed stream 112. In some embodiments, the fish friendly intake system 108 generates a sea life return stream 110. For example, the fish friendly intake system 108 may include low head and speed hatchery/fish diversion-type open screw impeller pump(s) (e.g., fish friendly) inside caissons (e.g., integrated with a dock structure) to extract subphotic (dark) seawater from near the bottom of a (e.g., 80 foot deep) ship channel (e.g., the maximum depth of the Suez canal). It should be noted that the dark seawater from the ship channel area has significantly lower sea life and organics content (typically less than 20 percent of the non-port area surface water), and the fish friendly pumps have demonstrated significant sea life survival rates (e.g., 97 percent).

The seawater may be routed from the pumps (e.g., open screw impeller pumps) to an enclosed (e.g., low light or dark) concrete channel raceway containing wedgewire screens, such as copper nickel wedgewire screens. A portion (e.g., approximately 50 percent) of the intake water is filtered through the screens to feed the desalination plant and the remainder is used as crossflow to provide a high survival sea life bypass. Based on field test results, these screens may achieve less than 10 percent entrainment and entrapment sea life loss when operated with low velocity water flow, through screens having approximately 0.5 mm openings, and with a 1-2 ft/s crossflow bypass. As such, the fish friendly intake system 108 may conform with certain government guidelines (e.g., the United States Environmental Protection Agency (EPA)).

In embodiments in which the fish friendly intake system 108 includes wedgewire, the wedgewire may include a metal alloy. For example, the wedgewire may include a 0.5 mm coating of copper nickel alloy, which may block or substantially reduce biofouling. A trace amount (<<1 mg/l) of copper may be in the filtrate water initially until the copper nickel fully passivates; however, using the water processing system disclosed herein, any trace copper in the feed seawater may be recovered as a minor impurity in the refractory grade magnesia product.

The sea life return stream 110 may be routed to a small reef pond adjacent to the fish friendly intake system 108 which provides a continuously flowing, sunlit reef system. The reef system serves as a low stress discharge for the sea life (e.g., within the sea life return stream 110) back into the sea. The water processing system 10 discussed herein may employ a combination of full water recovery, dark seawater intake, fish friendly pumps, and wedgewire screens to reduce entrainment and entrapment sea life loss to <2 percent of a conventional desalination plant using a travelling screen intake. By also providing the return through the reef system, these small losses can be more than made up by regrowth.

Following the fish friendly intake system 108, the fish-free stream 112 may be directed to an organic filter 114 to generate a second brine stream 116. In general, the organic filter 114 may remove organic compounds and/or microorganisms from the fish free stream 112 and/or feed stream 12. In some embodiments, the organic filter may include a biological activated carbon (BAC) filter to remove organic compounds from the fish free stream 112. Additionally or alternatively, organic filter 114 may include a dissolved air flotation (DAF) system. As such, when the fish free stream 112 contains algae from biological growth, the DAF system of the organic filter 114 may remove most of the algae. In this manner, the organic filter 114 removes essentially all of the assimilable organic carbon (mainly polysaccharides and organic acids from partially decomposed organic material), thereby minimizing downstream membrane biofouling. The BAC is periodically backwashed to the DAF to remove the captured organic carbon from the system.

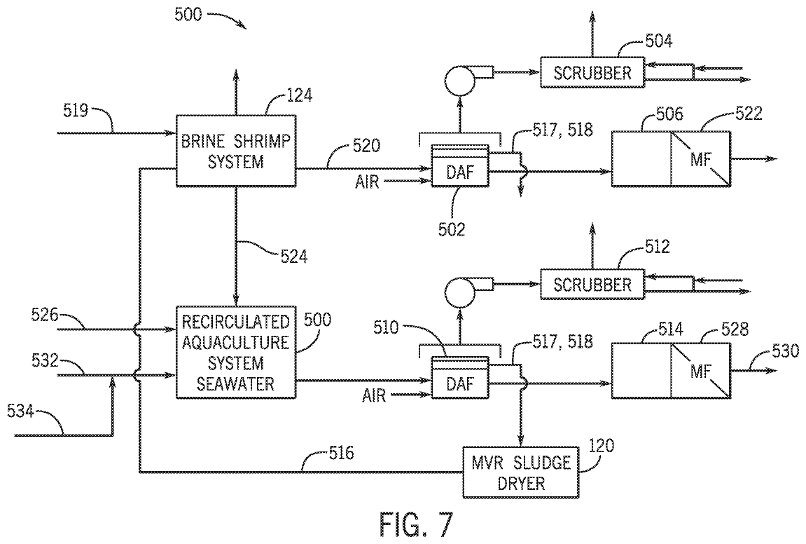

In some embodiments, the fish free stream 112 may be acidified to a pH less than approximately 7 using an acid (e.g., HCl 118) to substantially reduce barnacle and mussel growth before being routed to the organic filter 114 to remove bottom sediment, algae, and essentially all of the macro organic material. The disclosed water processing system 10 and methods may operate effectively under a broad range of biological, ship traffic, and storm conditions so that the design flow of low turbidity seawater may be available to the desalination plant at all times. The solids from the DAF system of the organic filter 114 may be routed to a mechanical vapor recompression (MVR) based steam bio-solids dryer, sterilizer, cooler, and bagging system (e.g., the dryer 120) for use in an aquaculture brine pond (e.g., aquaculture 122) and/or to prepare organic soils 124 for onsite or regional use. As discussed in more detail with respect to FIG. 7, an aquaculture return output 125 may be routed upstream of the organic filter 114 for further purifying.

The second brine stream 116 is then routed to the MF system 24 to remove any entrained bacterial biofilm and/or fine particulates from the BAC or degasifier of the organic filter 114 to generate an MF permeate stream 126. In some embodiments, an MF non-permeate stream 128 is periodically backwashed to the organic filter 114 to remove the particulates and biofilm. The MF permeate stream 126 is then routed to a nanofiltration (NF) unit 130, which removes nearly all of the magnesium, calcium, strontium, barium, and sulfate to generate an NF non-permeate stream 132, while allowing nearly all of the sodium, potassium, lithium, chloride, fluoride, and bromide to pass through in the NF permeate stream 134. Any residual organic material is also removed from the MF permeate stream 126 by the NF unit 130.

In some embodiments, the second brine stream 116 and/or the MF permeate stream 126 may be routed to a preheater that uses plant closed loop cooling water provided by a chiller 136 and/or a cooling tower 138 to heat the second brine stream/MF permeate stream to a constant temperature (e.g., 100 F) to enhance downstream membrane performance. The preheated seawater (e.g., the MF permeate stream 126) is mixed with hydrochloric acid to convert all of the bicarbonate to CO₂ and routed to a degasifier 140. The degasifier 140 generally removes the CO₂ from the MF permeate stream 126 (e.g., from the feed stream 12). Part of the degasifier effluent 142 is routed to a sodium hydroxide scrubber 144 which may produce a soda ash solution (e.g., Na2CO3) for internal plant use. The remainder of the degasifier effluent 142 may be routed to a dolime scrubber 148 which produces magnesium and calcium bicarbonate 150 to remineralize the desalinated water making it non-corrosive, as discussed below with regard to the desalinated water 40 produced by a seawater reverse osmosis (SWRO) unit 130. Accordingly, the degasifier 140 may remove essentially all the carbonate from the brine stream (e.g., the second brine stream 116), and the water processing system 10 may use separate brine softeners to produce a separate magnesium hydroxide slurry and calcium carbonate slurry. In this way, the separate slurries enable the recovered magnesium to be sold as magnesium hydroxide and the recovered calcium to be sold as gypsum. Further, the disclosed techniques include removing and recovering essentially all the CO₂ in the seawater and mixing it with dolomitic lime to produce magnesium bicarbonate and calcium bicarbonate for product water remineralization. This enables the desalinated water to both meet drinking water standards and be non-corrosive. Additionally, by using the desgasifier 140 and/or scrubbers 144, 148, the water processing system may produce carbonates internally, and thus eliminate the need for expensive limestone contactors or purchased food grade CO₂.

The sodium chloride rich NF permeate (e.g., the NF permeate stream 134) is routed to the SWRO unit 154 which produces desalinated water 155 and an SWRO concentrate stream 156, which may be stored for later use. In some embodiments, the SWRO unit 154 may be a high recovery, high efficiency (pressure exchanger equipped) two-stage seawater reverse osmosis (SWRO) unit 154. In some embodiments, a brackish water reverse osmosis (BWRO) membrane may be configured to receive the SWRO concentrate stream 156 from the SWRO unit 154 to further purify the NF permeate stream 134 and to produce demineralized water for steam production. In some embodiments, a natural gas fired cogen system based on a combustion turbine with a letdown steam turbine is used to generate most the steam for the calcium chloride evaporators and approximately 50 percent of the power utilized by the water processing system 10. In some embodiments, natural gas fired auxiliary boiler(s) may be used for startup and to provide supplemental steam to the plant calcium evaporators.

The BWRO concentrate may be recycled to the SWRO feed. The extensive seawater pretreatment and nanofiltration facilities elevated pH operation with SWRO benefits, such as removal of nearly all the boron, minimal biofouling, eliminating antiscalants, and enhancing permeate flux. In some embodiments, low pressure brackish water reverse osmosis membranes may be used in a partial second pass after the SWRO unit 154 to ensure certain entity regulations related to desalinated water requirements are met for both drinking water and high efficiency agricultural use.

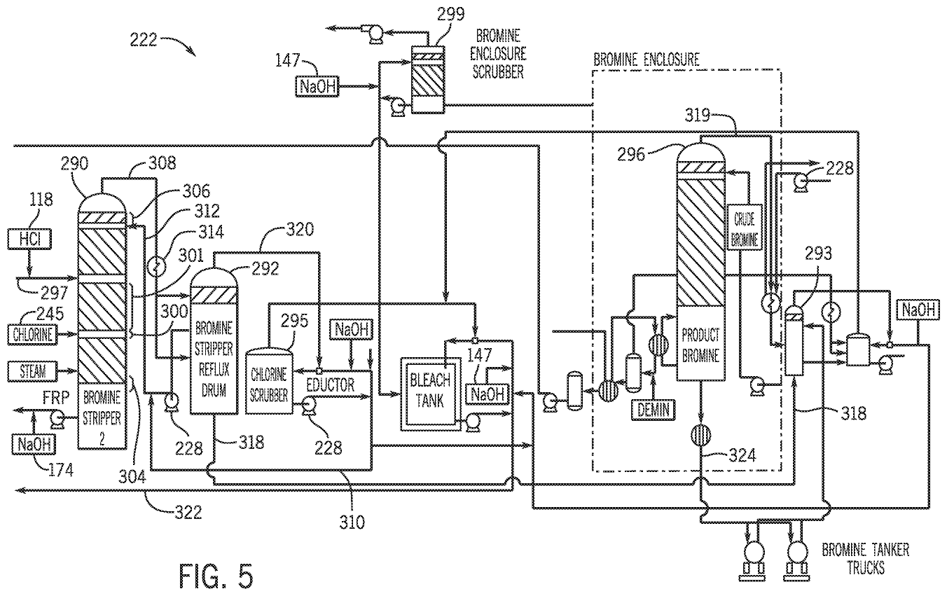

The desalinated water 40 produced by the SWRO unit 154 may be stored and/or remineralized using the RO permeate 158 to generate remineralized water 159, which may contain calcium and magnesium bicarbonate produced in the degasifier 140 scrubber to render the desalinated water non-corrosive. In some embodiments, recovered sodium fluoride 161 (e.g., as discussed with respect to FIG. 2B) and/or bleach 160 (e.g., generated by the MVR brine fluoride ion exchange discussed with respect to FIG. 2B) produced from self-produced, high purity (e.g., low bromide) sodium chloride, as discussed in more detail with respect to FIG. 5, is added to the remineralized desalinated water 159 for disinfection, and the resulting water is sent (e.g., directed or provided) to distribution.

The SWRO concentrate stream 156 may be routed to a sodium chloride storage system (tanks or covered pond) to stored the NaCl. The SWRO concentrate stream 156 may include approximately 8 wt % of NaCl. In an embodiment in which solar power is available, an MVR brine concentrator 162 may be used to further concentrate the SWRO concentrate stream 156 to produce a second SWRO concentrate 164. In some embodiments, the second SWRO concentrate may include approximately 25 wt % (i.e., near saturation) sodium chloride brine and produce desalinated water. The 25 wt % NaCl (e.g., the second SWRO concentrate) may be mixed with recycle salt streams and/or stored in a sodium chloride tank or covered pond for further use.

In some embodiments, the water processing system 10 may be integrated with a large scale district cooling system 166 having a cooling tower 138 and a chiller 136 that provides a chilled water supply. In such an embodiment, the SWRO concentrate stream 156 may be a routed to the cooling tower 138, which provides cooling water for a chilled water district cooling system 166. This may reduce the energy and capital cost of the MVR brine concentrator 162 because a portion of the brine evaporation duty is performed using waste heat from the cooling tower 138. Further, integrating the water processing system 10 with the district cooling system 166 described above also may obviate a separate seawater cooling water intake system and may eliminate the seawater cooling water blowdown discharge back to the ocean. Additional seawater intake and SWRO capacity is used to offset the loss of the condensate used by the MVR brine concentrator 162.

In the illustrated embodiment, water from the cooling tower 138 and/or water (e.g., desalinated water 40 produced using the SWRO unit 154) may be directed to a water tank 168. In general, the water tank 168 may store a portion of the product desalinated water 40, 155 for equipment flushing and purging of pump seals and instruments. The water tank 168 may supply fresh water to the cooling tower 138 for startup and to supplement the cooling provided by the feed seawater heat exchanger (e.g., precooler or preheater). In some embodiments, the closed loop cooling water from the MVR brine concentrator 162 is fully cooled by the feed seawater heat exchanger with minimal trim cooling, which is employed by the cooling tower 138. Desalinated water is used as makeup to the cooling tower 138 and the cooling tower blowdown may be routed to the seawater microfiltration inlet.

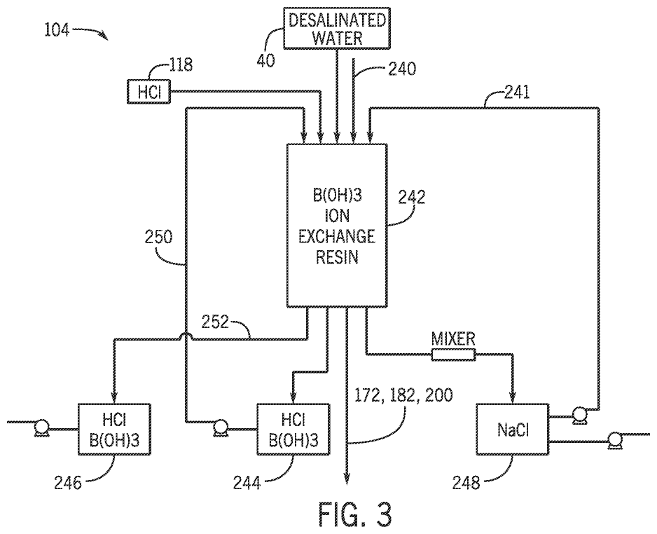

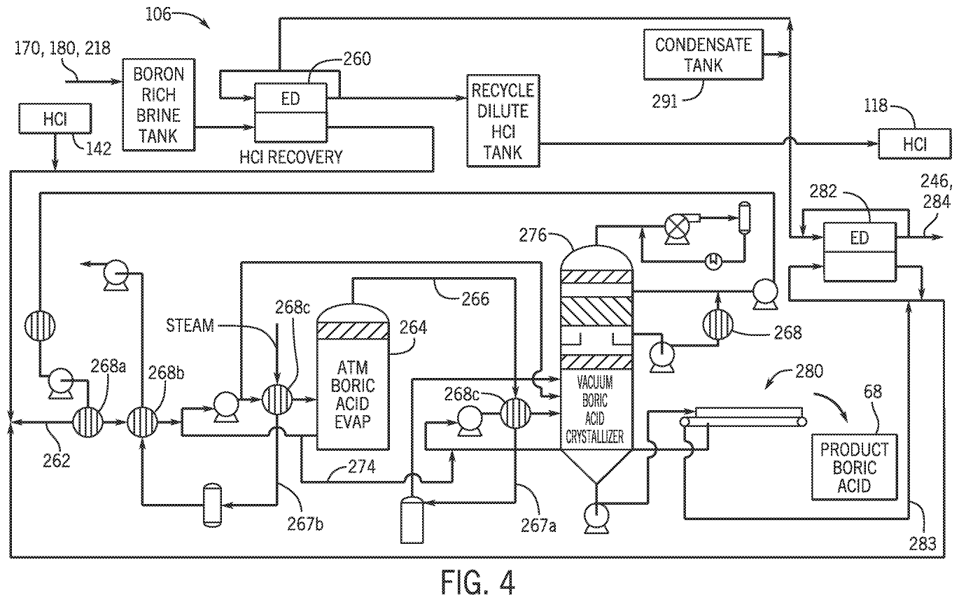

Following the MVR brine concentrator 162, the second SWRO concentrate stream 164 is fed to the boron removal system 104 (e.g., the first boron removal system 104a). The boron removal system generally removes the boron in the second SWRO concentrate stream 164 to generate a boric acid concentrate solution 170 that is fed to the boric acid recovery system 106 to produce boric acid 68, as discussed in more detail with respect to FIGS. 3 and 4. Additionally, the boron removal system 104 generates an essentially boron free brine solution 172 that is fed to a softener 173, which may produce dolime 152 using the boron free brine solution 172. The boron free brine solution 172 may be softened using NaOH 147 and Na2CO3 149 (e.g., a portion of stream 146) to produce magnesium hydroxide and calcium carbonate which is recycled to the magnesium hydroxide recovery system. In any case, the softened brine solution 172 is routed to a softener 173. The softened brine from 173 is routed to a MVR crystallizer 174, as discussed in more detail with respect to FIG. 2B.

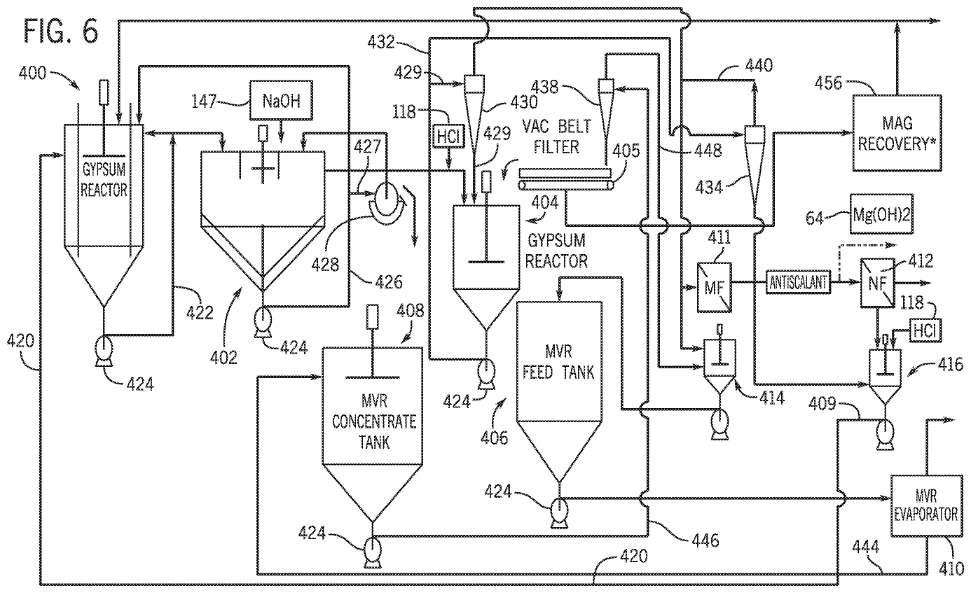

The NF non-permeate stream 132 (e.g., NF concentrate stream) is routed to a gypsum recovery system 176 (e.g., including a reactor, a settler, and a filter). The gypsum recovery system 176 may include a mixer, a settler, and the like, as discussed in more detail with respect to FIG. 6. The gypsum recovery system 176 generally recovers Ca and SO₄ in the NF non-permeate stream 132, thereby generating gypsum 60. The presence of gypsum seed crystals in the mixer (e.g., a turbulent mixer) of the gypsum recovery system 176 may facilitate gypsum precipitation kinetics, thereby enabling rapid gypsum precipitation. Moreover, in certain embodiments, the mixer may have a residence time of greater than approximately 2 hours. Therefore, the large residence time (e.g., greater than approximately 1 hour) in combination with turbulent mixing and a large solid content (e.g., greater than approximately 10 wt %) may enable formation of gypsum crystals having an average particle size of 100 microns or more. The larger gypsum crystals may facilitate removal of the gypsum 60 in the settler of the gypsum recovery system 176.

A gypsum filtrate stream 178 is fed to the boron removal system 104. As discussed in more detail with respect to FIG. 3, the boron removal system 104 may receive desalinated water (e.g., desalinated water 40), NaOH (e.g., NaOH 147), and HCl (e.g., HCl 84, 118) to facilitate removal of boron from the gypsum filtrate stream 178. The boron removal system 104 downstream of the gypsum recovery system 176 may produce a second boric acid concentrate solution 180 that is directed to the boric acid recovery system 106 and used to generate boric acid 68. In some embodiments, an effluent filter discharging to a sludger dryer may be used to remove dust in the gypsum filtrate stream 178. In the illustrated embodiment, the second essential boron free brine stream 182 generated by the boron removal system 104 is fed to a magnesium hydroxide recovery system 184. The magnesium hydroxide recovery system 184 generally produces a filter cake of magnesium hydroxide 64 and/or dolime 152. In some embodiments, the magnesium hydroxide 64 may be dried and calcined in a gas fired vertical multiple hearth furnace (e.g., a vertical calciner), briquetted, and then sintered in a gas fired vertical shaft kiln to produce refractory grade dead burned magnesia.

In the depicted embodiment, the magnesium hydroxide recovery system 184 produces a calcium chloride brine stream 185 that is routed to an MVR evaporator 186, a multi-effect evaporator 187, and a dryer 188 to produce calcium chloride 62. That is, the concentrated calcium chloride brine stream 185 from the magnesium hydroxide recovery system 184 is routed to another multi-effect steam evaporator 187 to produce desalinated water, concentrated calcium chloride brine, and solid sodium chloride salt which may be sent to the 25% sodium chloride brine storage.

In some embodiments, the calcium brine stream 185 may include approximately 20 wt % CaCl₂). The MVR evaporator 186 may include a mixer, a filter, and/or a settler, and may produce a concentrated calcium stream 189 by removing liquids (e.g., water) from the calcium brine stream 185. In some embodiments, the concentrated calcium stream 189 may include approximately 40 wt % CaCl₂). The multi-effect evaporator 187 further removes liquids from the concentrated calcium stream 189 to generate a second concentrated calcium chloride stream 190. The multi-effect evaporator 187 may also contain a centrifuge which removes the solid sodium chloride from the calcium chloride brine stream 185. In some embodiments, the second concentrated calcium chloride stream 190 may include approximately 70 wt % CaCl₂). Following the multi-effect evaporator 187, the dryer 188 removes additional liquids from the second concentrated calcium chloride stream 190 to generate a third concentrated calcium chloride stream 191. In some embodiments, the third concentrated calcium chloride stream 191 may include approximately 90 wt % CaCl₂), which may be used to form calcium chloride pellets. In some embodiments, a return calcium chloride stream 192 generated (e.g., by the MVR evaporator 186 and/or the multi-effect evaporator 187) with the concentrated calcium stream 189, the second concentrated calcium stream 190, and/or the third concentrated calcium stream is returned to the gypsum recovery system 176 to provide sufficient calcium to convert essentially all the sulfate to gypsum. In the depicted embodiment, the return calcium stream 192 is routed to the gypsum recovery system 176 where the calcium made be recovered to form gypsum.

The illustrated water processing system 10 also includes a brine shrimp system 193 that is fluidly coupled to the water tank 168. In general, the brine shrimp system 193 includes a pond, lake, or other body of water, and may be a limiting nursery feed that is self-produced, which minimizes supply chain risk. For example, the brine shrimp system 193 may receive a pretreated 8% NaCl brine, and self-supplied nutrients and minerals are provided as makeup to evaporation intensive aquaculture food production, such as brine shrimp and microalgae, as discussed in more detail with respect to FIG. 7. 15% NaCl brine is removed from the bottom of the pond, treated with DAF and MF membrane bioreactor, and routed to the brine concentrators, as discussed in more detail with respect to elements 502, 506, 510, and 514 of FIG. 7. This provides significant water for evaporation (e.g., ˜20% of the feed seawater) and avoids ˜50% of the expensive, energy intensive NaCl brine concentrators. Additional seawater feed and SWRO capacity is added to compensate for the lost desalinated water production from the brine concentrator condensate; however the added capacity has a much lower capital and energy cost than the avoided brine concentrator. The full size plant would support a 10,000 acre brine shrimp pond based on 6 ft/y evaporation (e.g., 200% of Great Salt Lake evaporation rate). Netting may be utilized to substantially reduce waterfowl predation.

The brine shrimp and microalgae produced and stored in the brine shrimp system 193 may receive low cost, high protein soybean meal and may be used in an intensive enclosed raceway aquaculture facility for production of high value seawater species (e.g., Salmon, Shrimp, Oysters, etc.) A DAF and MF (membrane bioreactor) recirculation and purge system may be used to substantially reduce organics, minerals, and solids buildup. The MF permeate purge may be routed to the BAC filter. The bio-solids may be sterilized and routed to the brine pond as nutrients. NF permeate and desalinated water makeup are provided as makeup along with supplemental minerals.

FIG. 2B is a block diagram of a second portion of the water processing system 10 of FIG. 2A, which includes a boron removal system 104 and a boric acid recovery system 106 configured to extract minerals from tailing streams such as nanofiltration and reverse osmosis non-permeate streams. As discussed above, with respect to FIG. 2A, the softened brine solution 172 generated by the boron removal system 104 and/or the softener 173 is directed to the MVR crystallizer 174. The MVR crystallizer 174 generates NaCl 63, a condensate 194 that may be routed to the water tank(s) 168, and a purge MVR brine solution 195. In the depicted embodiment, the MVR brine purge solution 195 is acidified with HCl to convert the fluoride to HF (pH<3) and fed to a fluoride ion exchange system to produce an essentially fluoride free brine routed to the softener 173 (i.e., as shown in FIG. 2A) and is regenerated with NaOH to produce an NaF brine stream 161a which is routed to the product RO permeate water stream 159 to provide beneficial fluoridation. In general the fluoride ion exchange system includes a basic material to remove acidic materials. For example the fluoride ion exchanger 202a may be amine-based, include a weak base anion exchange resin such as Amberlyst A21.

The MVR crystallizer 174 also generates a concentrated brine solution 196 that is fed to a second vacuum crystallizer 198 to generate a product KCl stream and to generate a second concentrated brine solution 200. Then, the second concentrated brine solution 200 is acidified with HCl to pH less than approximately 3 to convert the fluoride to HF and fed to the second fluoride ion exchange system 202 to produce an essentially fluoride free brine solution 204 and is regenerated with NaOH 147 to produce an NaF brine stream 205, which may be routed to the product RO permeate water stream 159 to provide fluoridation in the water processing system 10 for operations described herein. The second fluoride ion exchange system 202 includes a basic material to remove acidic materials. For example, the second fluoride ion exchange system 202 may be amine-based, include a weak base anion, or an exchange resin such as Amberlyst A21.

The third concentrated brine solution 204 is fed to a second NF unit 206 that generates a second NF non-permeate 207, which may be routed to a flow path upstream of the NF unit 130 for further filtering. The second NF unit 206 also produces a second NF permeate 208 that is fed to an MVR crystallizer 210, which produces a condensate that may be fed to the water tank 183, and the MVR crystallizer 210 also produces a recycle salt 212 (e.g., NaCl and KCl) that is routed to a flow path downstream from the MVR brine concentrator 162. The MVR crystallizer 210 also produces a tail brine 214 that is fed to a third boron removal system 216, which may include similar components to the boron removal system 104, as discussed in more detail with respect to FIG. 3. The third boron removal system 216 extracts the boron from the tail brine 214 to produce a boron rich brine 218 that may be routed to the boric acid recovery system 106. The third boron removal system 216 also produces an essentially boron free brine stream 220 that is fed to a bromine recovery system 222 that produces bromine 73, a bleach stream 224 (e.g., containing bleach 160 and/or NaF 161), and a bromine lean brine 226. The bromine lean brine 226 may be fed to a softener 228 to generate a recycle magnesium slurry 230 that is fed to a flow path upstream of the softener 173. The softener 228 also generates a softened lean brine 232 that is fed to a lithium recovery unit 234, which may generate lithium carbonate and produce a brine stream 236 that is fed to a flow path upstream of the second NF unit 206. In some embodiments, sodium carbonate (e.g., 30 wt %) may be added to the lithium recovery unit 234. In this way, the water processing plant 10 may recover various minerals, such as boron, bromine, gypsum, and the like, from the feed stream 12.

As discussed above, the water processing system 10 may include a boron removal system 104a, 104b, and/or 216 configured to extract boron from a boron rich stream 240, such as the second SWRO concentrate 164 or the gypsum filtrate stream 178 and the tail brine stream 214. To illustrate this, FIG. 3 is a block diagram of an embodiment of a boron removal system 50 that may be employed within the water processing system of FIGS. 2A-2B. In the illustrated embodiment, the boron removal system 50 includes a boric acid (B(OH)₃) ion exchange resin 242, a recycle acid tank 244, a spent acid tank 246, and a spent caustic tank 248. The boron removal system 104 produces a boric acid containing solution (e.g., stored in the spent acid tank 246) and a recycle sodium chloride solution (e.g., stored in the spent caustic tank 248) from the boron rich stream 240 (e.g., the second SWRO concentrate 164 or the gypsum filtrate stream 178). As discussed in more detail below, the boric acid 68 is produced by way of the B(OH)₃ ion exchange resin 242. However, during operation, the B(OH)₃ ion exchange resin 242 may become depleted. The B(OH)₃ ion exchange resin 242 may be regenerated by multiple purge processes, as discussed in more detail below.

For example, in operation, a first purge process may include feeding a first acid solution 250 from the recycle acid tank 244 to the B(OH)₃ ion exchange resin 242. Following addition of the first acid solution 250 to the B(OH)₃ ion exchange resin 242, a second acid solution 252 is produced, which is routed to the spent acid tank 246. For example, the first acid solution 250 may include approximately 5 wt % HCl with 2.5 wt % B(OH)₃, and the resulting second acid solution 252 may include approximately 1 wt % HCl and approximately 2.5 wt % B(OH)₃. In some embodiments, the first acid solution 250 may be an effluent from a previous purge, such as discussed below.

Following the first purge process, a second purge process may be performed that includes feeding an acid (e.g., HCl 118) to the B(OH)₃ ion exchange resin 242 and collecting the resulting effluent in the recycle acid tank 244. For example, a HCl 5 wt % acid may be directed to the B(OH)₃ ion exchange resin, which may purge B(OH)₃ from the B(OH)₃ ion exchange resin. The resulting effluent may include approximately 5 wt % HCl and approximately 2.5 wt % B(OH)₃ and may be stored in the recycle acid tank 244 and used for any subsequent purge processes.

Following the second purge process, a third purge process may be performed, in which desalinated water 40 is added to the B(OH)₃ ion exchange resin 242, and the resulting effluent is collected in the spent acid tank 246. For example, desalinated water may be directed to the B(OH)₃ ion exchange resin and may rinse residual HCl and B(OH)₃ from the acidified resin.

Following the third purge process, a fourth purge process may be performed including feeding a caustic polish solution 241 to the B(OH)₃ ion exchange resin 242 and collecting the resulting effluent in the spent caustic tank 248. For example, the caustic polish solution may contain between approximately 0 wt % to approximately 2 wt % NaCl brine. Any residual caustic in the fluid may be absorbed by the B(OH)₃ ion exchange resin to convert the fluid to a free base form. In this way, pH spikes, as well as resin loss, may be reduced or eliminated. In some embodiments, the spent caustic tank is emptied during operation.

Following the fourth purge process, a fifth purge process may be performed, in which a flow of the boron rich stream 240 (e.g., the second SWRO concentrate 164 or the gypsum filtrate stream 178) is fed to the B(OH)₃ ion exchange resin 242, and the resulting effluent is collected in the spent caustic tank 248. Additionally, a sixth purge process may be performed, in which the flow of the boron rich stream 240 is fed to the B(OH)₃ ion exchange resin, and the resulting effluent is directed away from the boron removal system to generate the essentially boron free brine solution 172, 180, and 220.

The first purge process, the second purge process, the third purge process, the fourth purge process, the fifth purge process, the sixth purge process, or any combination thereof, may be performed via the illustrated embodiment of the boron removal system of FIG. 3. The purge processes that are performed may depend on the product that is desired. For example, and as discussed above, the first purge process and the third purge process each produce an effluent for the spent acid tank 246 that includes boric acid and some HCl. As another non-limiting example of where certain purge processes may be omitted, the first purge process may be performed without the other purge processes (e.g., the second purge process, the third purge process, the fourth purge process, the fifth purge process, and the sixth purge process) to produce a product that include boric acid. Alternatively, the second purge process and the third purge process may also be included.

The fluid in the spent acid tank 246 shown in the illustrated embodiment of the boron removal system of FIG. 3 may include boric acid and HCl. The fluid in the spent acid tank 246 may be the boric acid concentrate solution 170 and/or the second boric acid concentrate solution 180. In any case, the fluid may be directed to the boric acid recovery system 106.

FIG. 4 is a block diagram of an embodiment of a boric acid recovery system 106 that may be employed within the water processing system of FIG. 2A-2B, in which the boric acid recovery system 106 is configured to produce boric acid 68, NaCl, KCl, trace salts, and water. In the illustrated embodiment, the boric acid concentrate solution 170 and/or the second boric acid concentrate solution 180 and/or the third boric acid concentrate solution 218 are directed to an electrodialysis (ED) unit 260 that extracts HCl 118 from the boric acid concentrate solution 170, the second boric acid concentrate solution 180, and/or the third boric acid concentrate solution 218 to generate a slow acid containing (e.g., less than approximately 0.2 wt % HCl) boric acid stream 262. For example, the HCl 118 produced by the ED unit 260 may include between approximately 1 wt % to approximately 3 wt % of HCl. In some embodiments, NaOH 147 may be added to the softened boric acid stream 262 to further neutralize any residual HCl in the low acid boric acid stream 262. For example, 25 wt % NaOH may be added to the low acid boric acid stream 262. The low acid boric acid stream 262 is the fed to an evaporator 264 (e.g., a double effect evaporator) that receives the product condensate streams 267a, 267b via heat exchangers 268 and driven by a pump. For example, a first heat exchanger 268a may heat the low acid boric acid stream 262 from approximately 100 F to approximately 140 F. Then, a second heat exchanger 268b may heat the low acid boric acid stream 262 to approximately 155 F. Further, a third heat exchanger 268c may heat the low acid boric acid stream 262 to approximately 240 F. In some embodiments, the second heat exchanger 268b and/or third heat exchanger 268c may use steam provided by a cogen to heat the low acid boric acid stream 262. The fluid (e.g., water) used to heat the low acid boric acid stream 262 may be stored in a condensate tank 291 for later use by the water processing system 10. The low acid boric acid stream 262 is fed from the heat exchangers to the evaporator 264, which removes water from the low acid boric acid stream 262 to generate a concentrated boric acid stream 274. For example, the evaporator 264 may operate under 12 pound per square inch absolute (psia) at approximately 210 F. The concentrated boric acid stream 274 may include approximately 25 wt % of boric acid. The concentrated boric acid stream 274 is directed to a vacuum crystallizer 276 that removes more of the water from the concentrated boric acid stream 274. For example, the vacuum crystallizer 276 may operate under 1 pound per square inch absolute (psia) at 115 F. The boric acid product 278 is then routed to a vacuum belt filter 280, where the boric acid product 278 is washed to remove residual acid and/or trace salts (e.g., NaCl and KCl) and is heated to remove water to produce boric acid 68. The illustrated embodiment of the boric acid recovery system 106 also includes a second ED 282 configured to recycle any trace salts. For example, the second ED 282 may receive a condensate from the condensate tank 291 and/or a brine purge 283 to produce a brine solution 246, 284 that includes approximately 1 wt % NaCl and/or less than approximately 100 mg/L of boric acid.

The softened, low boron sodium chloride brine (e.g., the brine solution 284) is routed to a MVR crystallizer to produce high purity, low bromide chemical grade salt and desalinated water. The tail brine from the MVR crystallizer is routed to a vacuum crystallizer to produce fertilizer grade potassium chloride and desalinated water. The tail brine from the vacuum crystallizer is routed to a second MVR crystallizer that produces desalinated water and a low purity mixed salt that is recycled back to the 25% sodium chloride storage where it is redissolved.

In some embodiments, the small tail brine flow (e.g., <50 GPM) from the mixed salt MVR crystallizer of FIG. 2A (e.g., tail brine stream 214) is routed to a tail brine storage unit, which may enhance system reliability. The tail brine from the tail brine storage may be routed to a fluid bed calcium fluoride removal unit (e.g., fluoride recovery unit of FIGS. 2A-2B) where self-generated calcium chloride brine is mixed with the tail brine to produce calcium fluoride and a treated tail brine. The treated tail brine is then routed to a bromine recovery unit which uses chlorine and steam in a distillation process to extract bromine from the treated tail brine. The bromine is then dried in a sulfuric acid drying system to produce product bromine.

As discussed above, the water processing plant 10 includes a bromine recovery system 222. FIG. 5 is a block diagram of an embodiment of a bromine recovery system 222 that may be employed within the water processing system of FIGS. 2A-2B. In general, the bromine recovery system 222 produces bromine 73. In the depicted embodiment, the bromine recovery system 222 includes a first distillation column 290 (e.g., a bromine stripper), a condenser and reflux drum 292, a second reflux drum 293, a stripper reflux drum scrubbing system 299, a second distillation column 296.

The bromine stripper (e.g., the first distillation column 290) receives chlorine 245, HCl 118, NaOH 147, and a bromide purge brine 297 (e.g., the softened brine stream 220 as discussed with respect to FIG. 2), which currently contains bromide, and produces a first bromine output 308. In the depicted embodiment, the chlorine 245 (e.g., chlorine gas) is fed to a bottom portion 300 of a middle packed section 301 of the bromine stripper 290, and steam 302 is fed to a top of a bottom packed section 304. The chlorine gas reacts with the bromide in the bromide purge brine 297, converting a majority of the bromide in the bromide purge brine 297 (e.g., greater than 80%) to bromine and producing dissolved chloride in the falling brine. The steam strips the bromine, HF, and excess chlorine out of the brine, thereby producing a crude bromine water vapor stream, which is routed to a top packed section 306 to produce a first bromine output 308 that is fed to the bromine stripper condenser and reflux drum 292.

The bromine depleted, chloride enriched, partially stripped brine stream from the middle packed section 301 is routed to the bottom packed section 304 along with low pressure (e.g., between approximately 5 to approximately 10 psig) steam 302. The low pressure steam (e.g., the steam 302) strips any residual bromine, chlorine, and HF out of the bromine depleted, chloride enriched brine stream, producing a lean brine stream suitable for recycling back to the sodium chloride or potassium chloride crystallizer section. Sufficient acid (e.g., HCl 118) is added to the feed (e.g., bromide purge brine 297) such that the pH of the first bromine output 308 to the bromine stripper condenser and reflux drum 292 is reduced to less than approximately 2, thereby ensuring essentially all of the chlorine in the brine (e.g., the first bromine output 308) exists as free chlorine, which can be completely stripped from the product brine by the chlorine scrubber.

Reflux water stream 310 from the bromine stripper reflux drum 292 is routed to the top packed section 306, and a second bromine output 312 (e.g., containing crude bromine vapor) and is also routed from the middle packed section of the bromine stripper condenser and reflux drum 292 to the bottom of the top packed section 306. The crude bromine vapor strips out most of the bromine, chlorine, and HF in the reflux water stream to produce a crude bromine vapor stream with increased bromine, chlorine, and HF content. The enriched crude bromine vapor stream 312 is routed to the bromine stripper condenser.

The output of the boron removal system 104 may include bromine (e.g., in the ionic form as sodium bromide salt) and/or trace amounts of fluoride (e.g., 1-10 mg/l). At least in some instances, a purge stream from a sodium chloride or potassium chloride crystallizer may be acidified with acid (e.g., HCl 118) to enable the stripped brine (e.g., from the middle packed section 306) to recycle back to the crystallizers (e.g., 202) and to be fed to the top of the middle packed section 300 of the multi-section (e.g., three-section) combination reactor and stripper (e.g., the first distillation column 290). In some embodiments, the first distillation column 290 may operate under low pressure (e.g., 9 psia and between approximately 180 to approximately 200 F). As such, the low-pressure conditions may substantially reduce or eliminate bromine and chlorine leakage, and facilitate use of a PVDF lined FRP stripping vessel with PVDF packing and demister pad. The reduced pH converts the fluoride to hydrofluoric acid (HF), which may be stripped by the stream and/or crude bromine, as discussed herein. Partially stripped reflux water from the bottom of the top packed section mixes with the feed brine at the top of the middle packed section to generate a enriched crude bromine vapor stream (e.g., wet bromine vapor).

The wet bromine vapor (e.g., the first bromine output 308) with the chlorine and HF impurities is routed to a SiC tubed condenser, which uses higher pressure open loop cooling water to condense the vapor and cool the liquid to 100 F. The reflux drum 292 operates under low pressure (10 psia) and also receives the vapor from product bromine loading. In the reflux drum the bromine and water form two liquid phases, water on top and wet bromine on the bottom. The wet bromine along with the feed bromine from the brine stripper reflux drum is returned to the top of the distillation column (e.g., at 306).

The enriched crude bromine vapor stream (e.g., the first bromine output 308) is routed to a cooling water condenser 314, which condenses most of the feed vapor stream. In some embodiments, the cooling water condenser may include silicon carbide (SiC) tubes which condenses most of the feed vapor stream by cooling the mixture to approximately 100 F at 9 psia. Air leakage and a portion of the more volatile HF and chlorine leave the top of the stripper reflux drum 292 and are routed to a scrubbing system. The condensed water and bromine phases are decanted in the bromine reflux drum 292 to produce a crude liquid bromine stream 318 and a bromine water stream 320. The bromine water stream 320 is mixed with a recycle bleach stream 322 from the first scrubber (e.g., the chlorine scrubber 295) and is fed to the top of the top packed section 306. The crude bromine liquid stream 318 containing dissolved chlorine, HF, and water is routed to the bottom of a bromine distillation reflux drum 294.

Any air leakage and a portion of the more volatile HF and chlorine leave the top of the stripper reflux drum 292 and are routed to an eductor where they are mixed with liquid from a recirculating alkaline scrubber (e.g., chloride scrubber 295), which converts most of the chlorine vapor to soluble sodium hypochlorite, sodium chloride, and water, and converts most of the HF to sodium fluoride and water. Desalinated water and sodium hydroxide are added to the circulating scrubber loop to limit sodium hypochlorite concentration to less than 20 wt %. A purge hypochlorite stream is taken from the first scrubber (e.g., chloride scrubber 295). A portion is routed to the return reflux bromine water stream, and the remainder sent to the second scrubber (e.g., the bromine scrubber 299) to purge fluoride from the system.

The air (e.g., from leakage described above) with trace amounts of chlorine and HF is routed to a second eductor on a circulating double wall atmospheric high density poly ethylene (HDPE) bleach tank. The residual chlorine is converted to sodium hypochlorite, sodium chloride, and water, and the residual HF is converted to sodium fluoride and water. Sodium hydroxide and water are added to the circulating bleach tank loop to limit the sodium hypochlorite concentration to less than 10 wt % to substantially reduce or eliminate hypochlorite tank emissions from the emitted double scrubbed air. The bleach stream from the second scrubber tank containing sodium hypochlorite, sodium chloride, sodium fluoride, and water is recycled back to the seawater pretreatment section of the water processing system where it is used to periodically clean the microfiltration (MF) membrane system (e.g., stream 322). All or a portion of the bleach stream from the second scrubber tank (e.g., stream 160) may also be routed to the product RO permeate stream 159 to provide chlorination and fluoridation of the product. The double wall storage tank is of sufficient size to hold the bleach solution between cleanings. Alternatively, sodium bisulfite may be mixed with the bleach to neutralize it to sodium chloride and sodium sulfate, thereby enabling the resulting solution to be continuously recycled to the feed seawater stream 12 entering the MF system 24 discussed with respect to FIG. 2A.

Crude bromine 319 from the bottom of the bromine distillation reflux drum 293, containing chlorine, HF, and water is routed to the top of a bromine distillation column 296 operating at low pressure (15 psig). For example, a reboiler with tantalum tubes or tantalum coated welded plates uses an internal closed loop 10 psig steam system (below column pressure). 50 psig steam from an external source may be used to generate the 10 psig closed loop steam. A small makeup demineralized and deaerated water steam and a small liquid purge to the closed loop cooling water system is used to maintain low closed loop boiler feed water conductivity. A small vapor purge to a higher pressure open loop cooling water condenser is taken to substantially reduce or eliminate buildup of non-condensibles. The condensate from the condenser is routed to the chlorine scrubber tank described below. A pH or conductivity instrument in the closed loop low pressure steam system (condensate from reboiler) may be used to detect a bromine leak into the closed loop steam system.

Although bromine has approximately four times the vapor pressure of water at the distillation conditions (e.g., vapor has a 4/1 Br₂/H₂O molar ratio), sufficient bromine is boiled in the reboiler (e.g., between approximately 4% to approximately 8%) to remove the small amount (e.g., less than approximately 1000 wppm, and less than approximately 0.9 mol %) of water dissolved in the feed crude bromine stream. Increased column temperature decreases the Br₂/H₂O vapor ratio; however, the bromine temperature in the bottom of the column is less than approximately 180 F at the 10-15 psig typical distillation column pressure for polyvinylidene fluoride PVDF lined fiberglass reinforced pump (FRP), which may be more effective than the alternative glass lining at higher temperature.

In addition to the lower vapor pressure water, the distillation column 296 may also remove essentially all the higher vapor pressure chlorine and HF at the increased reboiling ratio sufficient to remove the dissolved water. The purified bromine 324 from the bottom of the distillation column 296 is routed to a low pressure (e.g., below column pressure) closed loop cooling water tantalum tubed or tantalum coated welded plate exchanger. The closed loop cooling water is cooled with higher pressure chilled water or open loop cooling water. The closed loop cooling water system may have a small makeup stream from the closed loop low pressure steam system blowdown and a small blowdown stream to the chlorine scrubber. A pH or conductivity instrument in the closed loop cooling water may be used to detect a bromine leak into the closed loop cooling water.

The cooled (e.g., approximately 100 F), pressurized, purified (e.g., >99% purity), and dried (e.g., <100 wppm water) bromine from the product cooler may be routed directly into lead lined tanker trucks or isotanks (containerized tanks). A vapor return line from the trucks or isotank may be routed to the distillation reflux drum which is under vacuum (10 psia) minimizing any potential tanker truck or isotank leaks.

The small flow of bromine water containing less than approximately 3.5 wt % bromine (e.g., less than approximately 0.01 wt % of the feed bromine to the distillation column) from the reflux drum may be routed to the liquid sump of a chlorine scrubber. The closed loop steam purge condensate may also be routed to the liquid sump of the chlorine scrubber. The vapor from the reflux drum may be routed to an eductor on a circulating loop of a distillation chlorine scrubber. Sodium hydroxide may be added to the circulating loop to maintain a basic scrubber liquid pH (e.g., approximately 11), which may cause the bromine to be converted to sodium hypobromite bleach and sodium bromide, chlorine to be converted to sodium hypochlorite and sodium chloride, and HF to be converted to sodium fluoride. The small amount of vapor from the distillation chlorine scrubber may be routed to the vapor line from the chlorine scrubber on the bromine stripping column. A liquid purge bleach stream may be taken from the distillation scrubber to the double wall bleach tank. Desalinated makeup water is added to establish a bleach concentration less than 10 wt % NaOCl equivalent to substantially reduce or eliminate emission of bleach vapor from the double wall bleach tank vent.

In some embodiments, the bromine distillation column (e.g., the second distillation column 296) may not operate under low pressure (e.g., vacuum). Accordingly, to substantially reduce or eliminate vapor leaks from impacting the other water processing system sections, the bromine distillation section (e.g., including the second distillation column 296) may be contained at a relatively low pressure (e.g., below atmospheric pressure). A standard packed bed or spray type bromine scrubber using a circulating caustic solution (e.g., pH approximately between 11 to approximately 12) may be used to treat the air from the enclosure. A blower on the discharge of the scrubber creates a slight vacuum (e.g., 1-10 inches water) within the scrubber and enclosure. Bromine gas detectors within the enclosure may be used to detect leaks within the enclosure, thereby enabling the bromine distillation column to be remotely shutdown, fully drained, and the enclosure ventilated before entry to fix the leak. A small purge stream from the scrubber may be taken to the double wall bleach tank to maintain level in the scrubber sump.

The divalent ion rich (e.g., Ca, Mg, SO4) nanofiltration (NF) concentrate streams from full recovery desalination of seawater, brackish water, and some produced waters contains a supersaturated concentration of dissolved gypsum. A gypsum antiscalant may be used in the NF units to substantially reduce or eliminate NF membrane scaling while enhancing recovery of the monovalent NF permeate stream. Enhancing the NF permeate stream facilitates further treatment in reverse osmosis and brine concentration membranes to produce desalinated water and concentrated monovalent salt brine. However, the use of NF antiscalant may negatively affect the downstream gypsum recovery section used to treat the NF concentrate since the antiscalant contaminates the crystallization growth sites. This may effectively increase the gypsum solubility by up to 200% of the gypsum saturation index without antiscalant.

Dissolved sulfate in divalent NF concentrate may be nearly completely removed (e.g., >99%) in the gypsum recovery section. Lime (calcium hydroxide) or dolomitic lime (calcium, magnesium hydroxide) may be added to the brine from the gypsum recovery system to recover high purity magnesium hydroxide. If nearly all the sulfate remains upstream of the magnesium hydroxide recovery section, then the residual sulfate may react with the calcium in the added lime to produce a gypsum impurity in the magnesium hydroxide product. High magnesium hydroxide purity is desirable because the higher the magnesium hydroxide purity the higher the price. The largest and most profitable market for magnesium hydroxide is as a refractory feedstock, and impurities cause the refractory to breakdown prematurely.

Monovalent ions (e.g., Na, Cl, K, Br) and water are also in the NF concentrate stream 132. These components may be separated into a monovalent recycle stream so that the water and monovalent ions may be returned to the monovalent ion and water recovery section of the water processing system, thereby enabling the efficient recovery of desalinated water and production of substantially pure monovalent components (e.g., NaCl, KCl, Br₂) as industrial minerals and chemicals. An evaporator may be used to recover the water and produce gypsum even with the antiscalant present; however full evaporation recovery of all the water may incur a high capital and energy cost. In addition, the evaporator may not separate and recover the monovalent components.

FIG. 6 is a block diagram of an embodiment of a gypsum recovery system 176 that may be employed within the water processing system of FIGS. 2A-2B. As discussed above with respect to FIG. 2A, the gypsum recovery system 176 produces gypsum 60 using the NF non-permeate stream 132. In the depicted embodiment, the gypsum recovery system 176 includes a first reactor 400, a settler 402, a second reactor 404, an MVR feed tank 406, an MVR concentrate tank 408, an MVR evaporator 410, an MF system 411, an NF unit 412, an MVR mix tank 414, and a reactor mix tank 416.

In the depicted embodiment, the NF non-permeate 132 containing divalent ions, monovalent ions, and gypsum antiscalant, which is supersaturated in gypsum, is routed to the reactor mix tank 416. As shown, the mix tank 416 is configured to receive a non-permeate from the MF system 411 and the NF unit 412. In some embodiments, each of the MF system 411 and the NF unit 412 has a separate concentrate line to the mix tank 416 to substantially reduce or eliminate backflow contamination of the MF or NF membranes. For example, at least in some instances, the supersaturated NF concentrate 418 from the NF unit 412 may crystallize on a piping wall running from the NF unit 412 to the mix tank 416. Therefore, keeping the travel time between the NF unit 412 and the gypsum reactor relatively short (e.g., approximately 5 minutes) may reduce of eliminate crystallization. Hydrochloric acid 118 may be added to the mix tank to reduce pH to 3-5 to convert any residual bicarbonate to CO2 and reduce the effectiveness of the antiscalant (ie allow increased gypsum crystallization).

A gypsum mixture 420 generated by the mix tank 416 is routed to the first reactor 400 (e.g., gypsum reactor). In some embodiments, the gypsum mixture may include a recycle calcium chloride rich brine and the gypsum reactor mix tank slurry. In such embodiments, the flow of recycle calcium chloride rich brine may be adjusted so that the Ca/SO4 molar ratio in the reactor outlet is greater than 1 (e.g., between approximately 1.1 to approximately 1.8), which may reduce residual sulfate in the feed to the downstream magnesium hydroxide recovery unit. In the depicted embodiment, the first reactor 400 includes a cone bottom agitated tank with air spargers. In some embodiments, the first reactor 400 may have a residence time greater than approximately 30 minutes. The agitator and air spargers suspend and classify the gypsum crystals growing in the reactor. At least in some instances, a portion of the reactor bottoms containing the larger crystals is recirculated to the top of the reactor and the remainder is routed to a gypsum settler. The air spargers remove the residual CO₂ in the first reactor 400, thereby substantially reducing or eliminating calcium carbonate formation in the downstream magnesium hydroxide recovery system.

A portion of the gypsum reactor bottom slurry 422 is pumped (e.g., via at least one pump 424) to the settler 402. The settler 402 may be equipped with a small rapid mix section, where sodium or potassium hydroxide (e.g., lower cost sodium hydroxide) is mixed with the gypsum reactor bottom slurry 422 to increase the pH to 9. At least in some instances, sodium or potassium hydroxide may be used instead of lower cost lime because the sodium or potassium hydroxide may be soluble, and thus react relatively quickly with any residual dissolved free antiscalant in the gypsum reactor bottom slurry 422, which may cause the antiscalant to adsorb onto the larger gypsum crystals present in the gypsum reactor bottom slurry 422 within the rapid mix section. For example, all the residual antiscalant may be adsorbed onto larger gypsum particles at the outlet of the rapid mix section.

At least in some instances, nearly all (e.g., >98%) of the gypsum with essentially all the antiscalant adsorbed onto it may settle out in the settler 402 and produce between approximately 25 to approximately 50 wt % solids settler bottoms stream. The settler overflow 425 flows into the second reactor 404. A portion of the settler bottoms 426 is recycled to the first gypsum reactor 400, which may maintain a solids concentration in the reactor of between approximately 5 to approximately 10 wt % to provide sufficient gypsum growth sites to desupersaturate the liquid in the reactor to approximately 200% of the gypsum saturation index without antiscalant. Additionally, a remainder portion 427 of the settler 402 is routed to a vacuum drum filter 428. The vacuum drum filter 428 may use product desalinated water (e.g., desalinated water 40) to wash the filter cake to produce a low salt (e.g., less than approximately 1000 mg/l monovalent salt) low dust gypsum product with a low moisture content (e.g., between approximately 5 to approximately 20 wt %) with high gypsum purity (e.g., greater than approximately 90 wt % gypsum).

As discussed above, the settler overflow 425 of the first settler 400 is fed into the second reactor 404. In some embodiments, an acid (e.g., HCl 118) is mixed with the substantially antiscalant free settler overflow 425 to reduce the pH to between approximately 5 to approximately 6, which may condition the brine for the MVR brine concentrator (e.g., MVR evaporator 410) by substantially reducing or eliminating corrosion and/or carbonate scaling. The settler overflow 425 or the conditioned settler overflow (e.g., with HCl 118) is fed to the second reactor 404. In some embodiment, fresh seed gypsum is fed to the second reactor from the vacuum belt filter 405. Recycle seed gypsum 429 from the second gypsum reactor recycle hydroclone 430 is also fed to the second reactor 404, which may maintain between approximately 5 to approximately 15 wt % of slurry solids concentration. The second reactor 404 has a cone bottom and residence time of 10-30 minutes to enable the gypsum saturation index in the second reactor to decrease to <120%. The relatively high gypsum solids content, solids recirculation, agitation, and substantially antiscalant free solution may provide the further reduction of the gypsum saturation index.

The second reactor bottoms 432 are routed to the recycle hydroclone 430 and the product hydroclone 434. The bottoms from the recycle hydroclone 430 are routed to the second reactor 404 to maintain the desired solids concentration in the reactor, as generally discussed above. The bottoms 436 from the product hydroclone 434 are routed to the mix tank 416 and may serve as contaminated seed crystals for the first reactor 400. In some embodiments, the overhead stream 440 generated by the second gypsum reactor hydroclone 438 is routed to the MVR mix tank 414 with a portion routed to the salt and water purge microfiltration (MF) system 411.

The solids purge stream from the MF system 411 and at least a portion of the second reactor hydroclone overhead stream 440 are routed to the cone bottom MVR mix tank 414. From the mix tank 414, the mixture 442 is pumped to the cone bottom MVR feed tank 406, which may store approximately 15 hours of MVR feed. The MVR feed tank 406 may be recirculated to keep the fine gypsum solids in suspension. Low cost daytime only photovoltaic power may be used to operate the high power consuming MVR brine concentrator compressor (e.g., the MVR evaporator 410). The MVR feed tank 406 may be used to accumulate the feed when the MVR evaporator compressor is not operating. The MVR evaporator 410 may be recirculated continuously, even when the compressor is off to substantially reduce or eliminate solids settling in the evaporator. The MVR feed tank 406 and the MVR concentrate tank 408 may reduce the amount of power used by the gypsum recovery system 176. For example, the MVR feed tank 406 and the MVR concentrate tank 408 may be used so that the relatively higher power intensive MVR evaporator 410 may be operated during daytime hours using only low cost, renewable photovoltaic power.

The MVR brine evaporator 410 may be a standard gypsum seeded falling film evaporator. The MVR brine evaporator 410 produces condensate and a concentrated purge brine gypsum slurry. Typically, the solids concentration in the brine recirculation system is kept below 5 wt % by purging gypsum slurry from the system. Due to the high Ca/SO4 ratio (excess calcium) in the first gypsum reactor and the substantial absence of antiscalant in the MVR brine evaporator, the sulfate content of the concentrated purge brine is <2000 mg/l, the calcium content is >10,000 mg/l, and the magnesium content is >50,000 mg/l, thereby enabling the downstream magnesium hydroxide purity to be >98 wt %. The condensate is routed to the desalinated water system, and the concentrated purge brine gypsum slurry is routed to the MVR concentrate tank 408. The liquid evaporated off using the MVR bring evaporator 410 may be routed along the path 409 to the water tank 171 or along the path 411 to the NF unit 130, as discussed with respect to FIG. 2A.

The low sulfate, high magnesium and calcium MVR concentrate 444 in the MVR evaporator 410 is routed to an agitated cone bottom MVR concentrate tank 408 which stores approximately 15 hours of MVR concentrate. The MVR concentrate tank 408 is agitated and optionally recirculated, which may keep the fine gypsum solids in suspension. The MVR concentrate tank 408 is used to accumulate the concentrate when the MVR evaporator 410 compressor is operating and provides a substantially constant MVR concentrate 444 flow to the MVR concentrate hydroclone 438. The MVR concentrate hydroclone overhead stream 448 is recycled to the MVR mix tank 414.

The MVR concentrate hydroclone bottoms 446 (coarse solids fraction and brine) are routed to the vacuum belt filter 405 that separates the bottoms 446 into a substantially solids free product filtrate and gypsum MVR solids. The substantially solids free filtrate is routed to the magnesium hydroxide recovery system which uses lime or dolomitic lime to precipitate high purity magnesium hydroxide out of the filtrate. A portion of the calcium chloride brine from the magnesium hydroxide recovery system is recycled to the first gypsum reactor to achieve the elevated Ca/SO4 ratio described above. The substantially antiscalant free gypsum MVR solids are routed to the second gypsum reactor as seed crystals.

Gypsum antiscalant 401 may be mixed with the substantially solids free MF permeate 450 with a reduced gypsum saturation index (e.g., less than approximately 120%) and NF recycle permeate, which may reduce the gypsum saturation index to less than approximately 100%, and the mixture may be routed to the NF unit 414. The NF unit 414 may be a multi-pass unit that removes greater than approximately 90% of the magnesium and calcium into the concentrate stream, producing a predominately monovalent brine for recycle to the monovalent section of the water processing system. The divalent NF concentrate stream containing the antiscalant is routed to the first gypsum reactor mix tank for recycle to the first gypsum reactor. In some embodiments, sodium hydroxide may be used to treat the NF concentrate 418 that is ultimately routed to the settler 402, thereby causing substantially all of the antiscalant to be adsorbed onto the gypsum by removing caustic substances (e.g., residual acid). This may remove antiscalant in the settler overflow which is routed to the second gypsum reactor.

The MF system 412 and the NF unit 414 may use antiscalant 401 to process the second reactor hydroclone effluent 440 to produce a purge monovalent ion (e.g., mainly sodium chloride) and water stream. At least in some instances, the antiscalant 401 may be effective in the NF unit 412 because the gypsum saturation index in the feed to the NF unit 412 has been reduced to near 100% (i.e., crystallization/desupersaturation may not be impacted by antiscalant). This may significantly reduce the amount of vaporization that may occur in the MVR evaporator 410. The second nanofiltration concentrate stream containing antiscalant and supersaturated gypsum is routed to the antiscalant containing first gypsum reactor.

Thus, the water processing system may support a large, vertically integrated aquaculture system with energy savings and reduced net capital cost. In addition, the aquaculture system may use only NF permeate, NF permeate-based brine, and a small amount of desalinated water (e.g., all disease and predator free). This may reduce disease and biological contamination of the aquaculture system. Both the treated effluent 15% NaCl brine and the treated 3-4% seawater purge are routed to the water processing system as feeds. This eliminates all discharge from the aquaculture facility and avoids any potential for biological contamination of the native sea species.

In some embodiments, the water processing system is integrated with large scale, vertically integrated production, such as an aquaculture system. FIG. 7 is a block diagram of an embodiment of an aquaculture system 122. The depicted embodiment of the aquaculture system 122 includes a brine shrimp system 193, a first DAF 502, a scrubber 504, a first membrane bioreactor 506, the recirculated aquaculture system seawater 500, a second DAF 510, a second scrubber 512, a second membrane bioreactor 514, and the MVR sludge dryer 120. As generally discussed above with respect to FIG. 2A, the water processing plant may produce outputs (e.g., brine solutions) for an aquaculture system 122.

Operation, the MVR sludger dryer 120 feeds a nutrient rich sludge 516 that contains air 517 and/or ammonia 518 generated by the first DAF 502 and/or the second DAF 510. The nutrient rich sludge 516 is fed to the brine shrimp system 193 along with a brine stream 519 from the water processing plant (e.g., pretreated 8% NaCl brine). Accordingly, self-supplied nutrients and minerals are provided as makeup to evaporation intensive aquaculture food production (brine shrimp and microalgae). A second brine stream 520 (e.g., 15% NaCl brine) is removed from the bottom of the pond, treated with the first DAF 502 and an MF system 522 of the first membrane bioreactor 506, and routed to the brine concentrators of the water processing plant, as discussed with respect to FIG. 2A. This provides significant water for evaporation (e.g., ˜20% of the feed seawater) and may reduce the use of the expensive, energy intensive NaCl brine concentrators (e.g., evaporators). Additional seawater feed and SWRO capacity is added to compensate for the lost desalinated water production from the brine concentrator condensate; however the added capacity has a much lower capital and energy cost than the avoided brine concentrator. The full size plant would support a 10,000 acre brine shrimp pond based on 6 ft/y evaporation (e.g., 200% of Great Salt Lake evaporation rate). Netting may be utilized to substantially reduce waterfowl predation.

The brine shrimp and microalgae 524 produced in the brine shrimp system 193 and a low cost, high protein feed 526 may be used in an intensive enclosed raceway aquaculture facility for production of high value seawater species (e.g., Salmon, Shrimp, Oysters, etc.) The second DAF 510 and an MF system 528 of the second membrane bioreactor recirculation and purge system 514 may be used to substantially reduce or eliminate organics, minerals, and solids buildup. The MF permeate purge 530 may be routed to the BAC filter (e.g., as discussed above with respect to the organic filter 114 of FIG. 2A). The bio-solids may be sterilized and routed to the brine pond as nutrients. NF permeate 532 (e.g., the NF permeate 134 as discussed above with respect to the FIG. 2A) and desalinated water 534 (e.g., desalinated water 40 as discussed above with respect to the FIG. 2A) are provided as makeup along with supplemental minerals.

Thus, the water processing system may support a large, vertically integrated aquaculture system 122 with energy savings and reduced net capital cost. In addition, the aquaculture system may use only NF permeate, NF permeate-based brine, and a small amount of desalinated water (e.g., all disease and predator free). This may reduce disease and biological contamination of the aquaculture system. Both the treated effluent 15% NaCl brine and the treated 3-4% seawater purge are routed to the water processing system as feeds. This substantially reduces or eliminates all discharge from the aquaculture facility and substantially reduces or eliminates any potential for biological contamination of the native sea species.

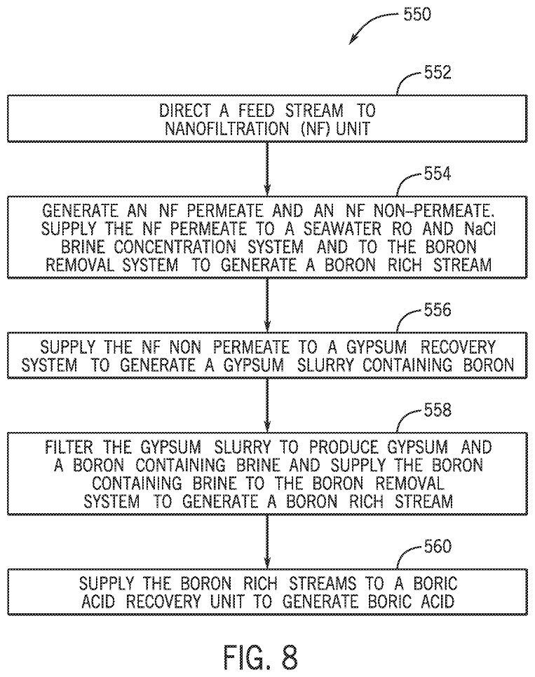

FIG. 8 is a flow diagram of an embodiment of a method 550 by which the water processing system generates certain minerals, as discussed herein. The method includes directing (block 552) a feed stream to a nanofiltration (NF) unit disposed upstream of a mineral removal system, in which the feed stream includes multiple minerals. For example, as discussed above with respect to FIG. 2A, the feed stream is directed to the NF unit. In some embodiments, the feed stream is also fed into the fish friendly intake system, the organic filter, the MF system, or any combination thereof.

The method also includes generating (block 554) an NF permeate stream (e.g., the NF permeate stream 134) and an NF non-permeate stream (e.g., the NF non-permeate stream 132) from the feed stream via the NF unit, and the NF non-permeate stream has a first portion of the minerals, and the NF permeate stream has a second portion of the minerals. As generally discussed herein, the NF permeate stream may be directed to the boron removal system, and the NF non-permeate stream may be directed to the gypsum recovery system.

Further, the method includes supplying (block 556) the NF permeate stream to a gypsum recovery system. For example, and as discussed above with respect to FIG. 2A and FIG. 5, the gypsum recovery system is configured to remove the first portion of the minerals from the NF-non permeate stream to generate a gypsum filtrate, wherein the gypsum filtrate includes boron.

Further, the method includes supplying (block 558) the gypsum filtrate to a boron removal system, in which the boron removal system is configured to generate a boron rich stream. The method also includes supplying (block 560) the boron rich stream to a boric acid recovery unit, in which the boric acid recovery unit is configured to generate boric acid and a brine stream including a third portion of the minerals based on the boron rich stream. In some embodiments, the method 550 may also include supplying the brine stream to a bromine recovery system, such as the bromine recovery system 222, as discussed in above with respect to FIG. 2B.

Accordingly, the present disclosure relates to a water processing system that is configured to extract valuable salts and minerals left over after the desalination process. For example, the water processing system may include a boron removal system and/or a boric acid recovery system that recovers boron in the form of boric acid from a feed stream. As another non-limiting example, the water processing system may also include a bromine recovery system that generates bromine from the bromide ions in solution. As a further non-limiting example, the water processing system may also include a gypsum recovery system with an MF system and an NF unit (e.g., a hybrid filtering system). In this way, the disclosure techniques enable various valuable salts and minerals to be extracted from a water source and used for certain purposes, industrial or otherwise.

While only certain features have been illustrated and described herein, many modifications and changes will occur to those skilled in the art. It is, therefore, to be understood that the appended claims are intended to cover all such modifications and changes as fall within the true spirit of the disclosure).

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a nanofiltration (NF) system configured to generate an NF permeate stream and an NF non-permeate stream from a brine stream from a water treatment system, wherein the NF permeate stream comprises boron;
a boron removal system disposed downstream from the NF system and configured to generate a boric acid concentrate stream and a softened brine stream based on the NF non-permeate stream, wherein the NF non-permeate stream comprises boron; and
a boric acid recovery system configured to receive the boric acid concentrate stream and to generate boric acid from the boric acid concentrate stream.

2. The system of claim 1, wherein the boron removal system comprises an ion exchange based boron removal system.

3. The system of claim 1, comprising a bromine recovery system disposed downstream from the boron removal system, wherein the bromine recovery system is configured to generate bromine based on the softened brine stream.

4. The system of claim 3, wherein the bromine recovery system comprises a two-column distillation system configured to generate the bromine, a bleach stream, and a sodium fluoride stream.

5. The system of claim 1, comprising a gypsum recovery system disposed upstream of the boron removal system, wherein the gypsum recovery system is configured to receive the NF non-permeate stream and to generate a gypsum filtrate stream, wherein the gypsum filtrate stream comprises boron; and
wherein the boron removal system is configured to receive the gypsum filtrate stream and to generate the boric acid concentrate stream based on the gypsum filtrate stream.

6. The system of claim 5, wherein the gypsum recovery system comprises a microfiltration (MF) unit and a nanofiltration (NF) unit.

7. The system of claim 1, comprising an additional boron removal system disposed downstream from the NF system and configured to generate an additional boric acid concentrate stream based on the NF permeate stream; and
wherein the boric acid recovery system is configured to receive the boric acid concentrate stream and the additional boric acid concentrate stream and to generate the boric acid using the boric acid concentrate stream and the additional boric acid concentrate stream.

8. The system of claim 1, wherein the boric acid recovery system comprises a double effect evaporator.

9. The system of claim 1, wherein the boric acid recovery system is configured to generate the boric acid using the boric acid concentrate stream and based on the NF permeate stream.

10. The system of claim 1, comprising a magnesium hydroxide recovery system disposed downstream of the boron removal system, wherein the magnesium hydroxide recovery system is configured to receive the softened brine stream and generate magnesium hydroxide based on the softened brine stream.

11. A system comprising:
a nanofiltration (NF) system configured to generate an NF permeate stream and an NF non-permeate stream from a brine stream from a water treatment system, wherein the NF permeate comprises boron, and wherein the NF non-permeate stream comprises boron;
a boron removal system disposed downstream of the NF system and configured to generate a boric acid concentrate stream and a softened brine stream based on the NF non-permeate stream; and
a bromine recovery system disposed downstream from the boron removal system, wherein the bromine recovery system is configured to generate bromine based on the softened brine stream.

12. The system of claim 11, wherein the bromine recovery system comprises a two-column distillation system configured to generate reflux the softened brine and generate the bromine, a bleach stream, and a sodium fluoride stream based on the refluxing of the softened brine.

13. The system of claim 11, comprising a gypsum recovery system disposed upstream of the boron removal system, wherein the gypsum recovery system is configured to receive the NF non-permeate stream and to generate a gypsum filtrate stream, wherein the gypsum filtrate stream comprises boron; and
wherein the boron removal system is configured to receive the gypsum filtrate stream and to generate the boric acid concentrate stream based on the gypsum filtrate stream.

14. The system of claim 10, comprising a boric acid recovery system configured to receive the boric acid concentrate stream and to generate boric acid.

15. A method comprising:
directing a feed stream to a nanofiltration (NF) system disposed upstream of a mineral removal system, wherein the feed stream comprises a plurality of minerals;
generating an NF permeate stream and an NF non-permeate stream from the feed stream via the NF unit, wherein the NF non-permeate stream comprises a first portion of the plurality of minerals, and the NF permeate stream comprises a second portion of the plurality of minerals;
directing the NF non-permeate stream to a gypsum recovery system, wherein the gypsum recovery system is configured to remove the first portion of the plurality of minerals from the NF non-permeate stream to generate a gypsum filtrate stream, wherein the gypsum filtrate comprises boron;
supplying the gypsum filtrate to a boron removal system, wherein the boron removal system is configured to generate a boron rich stream and a non-boron containing stream; and
supplying the boron rich stream to a boric acid recovery system, wherein the boric acid recovery system is configured to generate boric acid and boron free brine solution comprising a third portion of the plurality of minerals based on the boron rich stream.

16. The method of claim 15, comprising supplying the boron free brine solution to a bromine recovery system, wherein the bromine recovery system is configured to generate a bromine product based on the brine stream.

17. The method of claim 16, wherein the bromine product comprises bromine, and an amount of water within the bromine product is less than approximately 10 percent by weight of the bromine product; and
the method comprises:
adding an acid to the bromine product to neutralize a portion of chlorine if present within the bromine product, to neutralize a portion of fluorine if present within the bromine product, and to reduce an acidity of a portion of the water if present within the bromine product; and
wherein the bromine recovery system is configured to reflux the brine stream to generate the bromine.

18. The method of claim 17, wherein directing the brine solution to the bromine recovery system comprises directing the brine solution to a first distillation system configured to generate a first bromine product by refluxing the brine solution; and
supplying the first bromine product to a second distillation system configured to generate a second bromine product based on the first bromine product, wherein a first pressure of the first distillation system while the first bromine product is being refluxed is lower than a second pressure of the second distillation system while the second bromine product is being refluxed.

19. The method of claim 18, wherein the first bromine product is refluxed under positive pressure within the second distillation system.

20. The method of claim 16, comprising generating a calcium chloride brine based on the non-boron containing stream.

21. (canceled)

22. (canceled)
